(19) United States
(12) Patent Application Publication
(10) Pub. No.: US 2026/0038110 A1
(43) Pub. Date: Feb. 5, 2026

(54) WAFER INSPECTION SYSTEM AND METHOD UTILIZING ARTIFICIAL INTELLIGENCE MACHINE LEARNING MODELS

(71) Applicant: CHENG MEI INSTRUMENT TECHNOLOGY CO., LTD., HSINCHU COUNTY (TW)

(72) Inventors: CHIH-YUAN LIN, HSINCHU COUNTY (TW); CHENG-TAO TSAI, HSINCHU COUNTY (TW); CHENG TING CHIANG, HSINCHU COUNTY (TW)

(21) Appl. No.: 19/283,125

(22) Filed: Jul. 28, 2025

(30) Foreign Application Priority Data
Jul. 30, 2024 (TW) 113128372

(51) Int. Cl. G06T 7/00; G06V 10/764

(52) U.S. Cl. CPC G06T 7/001; G06V 10/764; G06T 2207/10132; G06T 2207/10152; G06T 2207/20081; G06T 2207/30148

(57) ABSTRACT

A wafer inspection system includes: an inspection platform, accommodating wafer to be inspected including multiple dies, an illumination device, a sensing device, a control module, for each of the dies, controlling the illumination device to illuminate the die with different combinations of light sources in multiple time periods and controlling the sensing device to obtain multiple sets of image data of the die in the time periods, and a computing module, training a deep learning model according to the image data of the dies to determine multiple classification features, classifying the dies according to the classification features to categorize those determined to be same into a same category, defining dies that belong to a first category having a greatest number of dies as first-category dies, and defining dies that do not belong to the first category as second-category dies.

### CROSS-REFERENCE TO RELATED APPLICATIONS

This application claims priority of Taiwan application No. 113128372, filed on Jul. 30, 2024, which is incorporated by reference in its entirety.

### BACKGROUND OF THE PRESENT DISCLOSURE

### Field of the Present Disclosure

The present disclosure relates to a wafer inspection system, and more particularly to a wafer inspection system utilizing artificial intelligence machine learning models to process large amounts of image data generated by different light sources and timing controls.

### Description of the Prior Art

Accompanied with miniaturization of integrated circuits, defect inspection in integrated circuits has also become increasingly difficult. In the prior art, one common method is to utilize an electronic microscope to inspect defects in wafer. However, this method involves high equipment costs and professional operating techniques and is applicable to only defect detection of specific types, therefore, it is unsuitable for high-throughput inspection processes in wafer production. Another common inspection method is to utilize the optical inspection technology to inspect defects by means of comparing images of surfaces of wafer with reference images. However, because different reference images may be needed for different production processes and dies, it is necessary for inspection service providers to continually update and supplement reference image databases to ensure that defects in wafer can be accurately identified.

In addition to the issue of reference images, different patterns and forms of defects account for another challenge. For example, different types of defects and particles may be present on wafer, and these different types of undesirable forms of defects may need to be inspected by utilizing different inspection methods and techniques. Moreover, along with constantly changing production processes and continuously updated die requirements, inspection methods also need to innovate and improve persistently in order to adapt to these changes and requirements. Therefore, how to develop a wafer inspection technique suitable for different production processes and able to distinguish various defects has become an issue to be solved.

### SUMMARY OF THE PRESENT DISCLOSURE

One aspect of the present disclosure provides a wafer inspection system. The wafer inspection system includes an inspection platform, an illumination device, a sensing device, a control module, and a computing module. The inspection platform is configured to accommodate a piece of wafer to be inspected comprising a plurality of dies. The illumination device includes a plurality of light sources, and is configured to illuminate the wafer to be inspected. The sensing device is configured to sense lights reflected from the wafer to be inspected. The control module is coupled to the illumination device and the sensing device. The control module is configured to, for each of the plurality of dies, control the illumination device to illuminate the die with a plurality of combinations of light sources in a plurality of light sensing time periods, and control the sensing device to obtain a plurality of sets of image data of the die in the light sensing time periods. Each of the plurality of combinations of light sources comprises at least one of the plurality of light sources. The computing module is configured to receive a plurality of sets of image data of the plurality of dies, train at least one first deep learning model to determine a plurality of classification features according to the plurality of sets of image data of the plurality of dies, classify the plurality of dies according to the plurality of classification features to categorize those determined to be same into a same category, define a plurality of dies that belong to a first category having a greatest number of dies as a plurality of first-category dies, and define a plurality of dies that do not belong to the first category as a plurality of second-category dies.

Another aspect of the present disclosure provides a method for wafer inspection using a wafer inspection system. The wafer inspection system includes an inspection platform, an illumination device, a sensing device, a control module, and a computing module. The control module is coupled to the illumination device and the sensing device. The method includes accommodating, by the inspection platform, a piece of wafer to be inspected, wherein the wafer to be inspected comprises a plurality of dies, controlling, by the control module, the illumination device to illuminate each of the dies with a plurality of combinations of light sources in a plurality of light sensing time periods, controlling, by the control module, the sensing device to obtain a plurality of sets of image data of each of the plurality of dies in the plurality of light sensing time periods, wherein each of the plurality of combinations of light sources comprises at least one of the plurality of light sources, training, by the computing module, at least one first deep learning model according to at least the plurality of sets of image data of the dies to determine a plurality of classification features, classifying, by the computing module, the plurality of dies according to the plurality of classification features to categorize those determined to be same into a same category, defining, by the computing module, a plurality of dies that belong to a first category having a greatest number of dies as a plurality of first-category dies, and defining, by the computing module, a plurality of dies that do not belong to the first category as a plurality of second-category dies.

### BRIEF DESCRIPTION OF THE DRAWINGS

FIG. 1 is a schematic diagram of a wafer inspection system according to an embodiment of the present disclosure.

FIG. 2 is a schematic diagram of wafer according to an embodiment of the present disclosure.

FIG. 3 is a timing diagram of operations of an illumination device and a sensing device in FIG. 1.

FIG. 4 is a schematic diagram of a multilayer deep learning model according to an embodiment of the present disclosure.

FIG. 5 is another timing diagram of operations of the illumination device and the sensing device in FIG. 1.

FIG. 6 is a schematic diagram of an inspection platform moving dies according to an embodiment of the present disclosure.

FIG. 7 is a schematic diagram of a wafer inspection system according to another embodiment of the present disclosure.

FIG. 8 is a timing diagram of operations of an ultrasonic transmitter and an ultrasonic sensor in FIG. 7.

FIG. 9 is a flowchart of a method performed by a wafer inspection system according to an embodiment of the present disclosure.

### DETAILED DESCRIPTION OF THE EMBODIMENTS

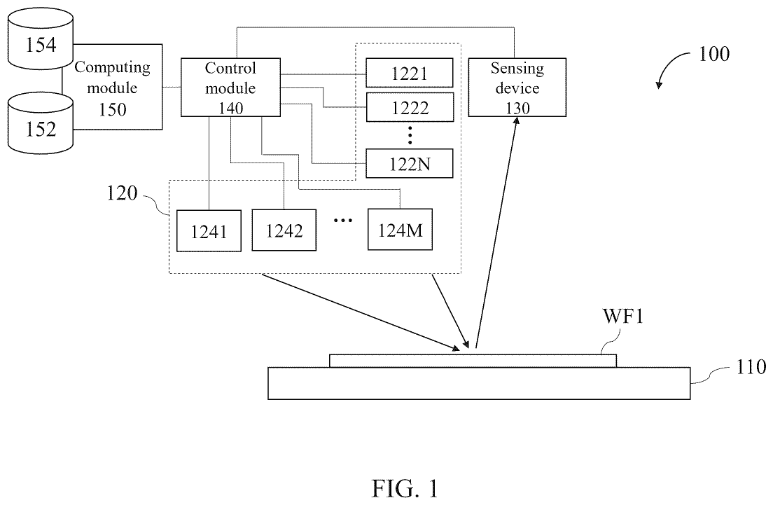

FIG. 1 shows a schematic diagram of a wafer inspection system 100 according to an embodiment of the present disclosure. The wafer inspection system 100 includes an inspection platform 110, an illumination device 120, a sensing device 130, a control module 140, and a computing module 150.

The detection platform 110 may accommodate a wafer WF1 to be inspected. In some embodiments, the inspection platform 110 may secure the wafer WF1 at the inspection platform 110 by a fixture and/or by means of suction during an inspection process of the wafer WF1, so as to facilitate the progress of inspection. The illumination device 120 may include multiple light sources, for example but not limited to, light sources 1221 to 122N and light sources 1241 to 124M, where N and M are integers greater than 1. The light sources 1221 to 122N and the light sources 1241 to 124M may illuminate the wafer WF1, and the sensing device 130 may sense lights reflected from the wafer WF1 to thereby generate corresponding image data (for example, photographs).

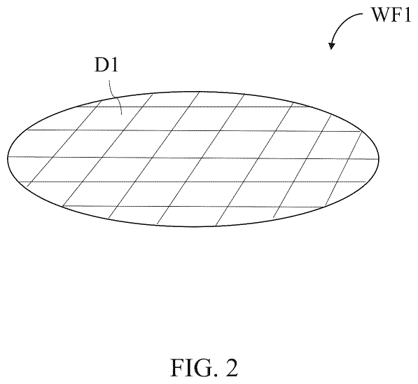

FIG. 2 shows a schematic diagram of the wafer WF1 according to an embodiment of the present disclosure. As shown in FIG. 2, the wafer WF1 may include multiple dies D1. In some embodiments, the inspection platform 110, the illumination device 120 and the sensing device 130 may be correspondingly arranged for a user to readily adjust a position of the wafer WF1 and adjust relative positions of the illumination device 120 and the sensing device 130 by the inspection platform 110, so as to inspect each of the dies D1 of the wafer WF1. In some embodiments, the inspection platform 110 may further include multiple optical path adjusters (not shown in the drawings). The optical path adjusters may each include, for example, a lens, and may be configured to adjust optical paths of the light sources 1221 to 1224N and the light sources 1241 to 124M incident on the wafer WF1, and/or adjust optical paths of reflected lights from the wafer WF1 entering the sensing device 130.

As shown in FIG. 1, the control module 140 may be coupled to the illumination device 120 and the sensing device 130, and may control the illumination device 120 and the sensing device 130 to obtain related image data of each of the dies D1 of the wafer WF1. For example, for each of the dies D1, the control module 140 may control the illumination device 120 to illuminate the die with multiple different combinations of light sources in multiple light sensing time periods, and control the sensing device 130 to obtain multiple sets of image data of the die in the light sensing time periods.

In some embodiments, the light sources 1221 to 122N may be bright field light sources, and the light sources 1241 to 124M may be dark field light sources; however, the present disclosure is not limited to the examples above. In some embodiments, the light sources 1221 to 122N and the light sources 1241 to 124M may include light emitting diodes (LEDs) light sources and laser light sources.

Moreover, in some embodiments, any two of the light sources 1221 to 122N may correspond to different wavebands, different intensities, different polarization states, or any combination of the above. In other words, the light sources 1221 to 122N may be configured to respectively provide bright field lights in different wavebands, different intensities and/or different polarization states. Similarly, any two of the light sources 1241 to 124M may correspond to different illumination angles, different wavebands, different intensities, different polarization states, or any combination of the above. That is, the light sources 1241 to 124M may be configured to provide dark field lights in different illumination angles, different wavebands, different intensities and/or different polarization states. Moreover, in some embodiments, the light sources 1221 to 122N and the light sources 1241 to 124M may also include other types of light sources, for example, backlight light sources, and any two of the backlight light sources may correspond to different wavebands, different intensities, different polarization states, or any combination of the above.

For example, the light source 1221 may correspond to a waveband of visible light, and the light source 1222 may correspond to a waveband of invisible light, for example, a waveband of ultraviolet light or infrared light. Since light of different wavebands can have different penetrating capabilities and refractive indices for dies, it may help to obtain image data having different information by illumination with different lights, and thus chances of identifying defects can be increased. For another example, in some embodiments, the light source 1222 may transmit a light having a polarization direction parallel to an incident plane (e.g., having a P polarization state), and the light source 122N may transmit a light having a polarization direction perpendicular to an incident plane (e.g., having an S polarization state). Since lights in different polarization states may also have different penetrating capabilities and refraction angles for different materials (e.g., crystal and non-crystal materials), it is also possible to present different features of the dies by illumination with lights of different polarization states, thereby obtaining image data with different information and increasing the chances of detecting defects of the dies.

In some embodiments, the control module 140 may adopt light source combinations choosing from the light sources 1221 to 122N and the light sources 1241 to 124M in the illumination device 120 arbitrarily to illuminate the die to be inspected, wherein each of the light source combination may include at least one of the light sources 1221 to 122N and the light sources 1241 to 124M.

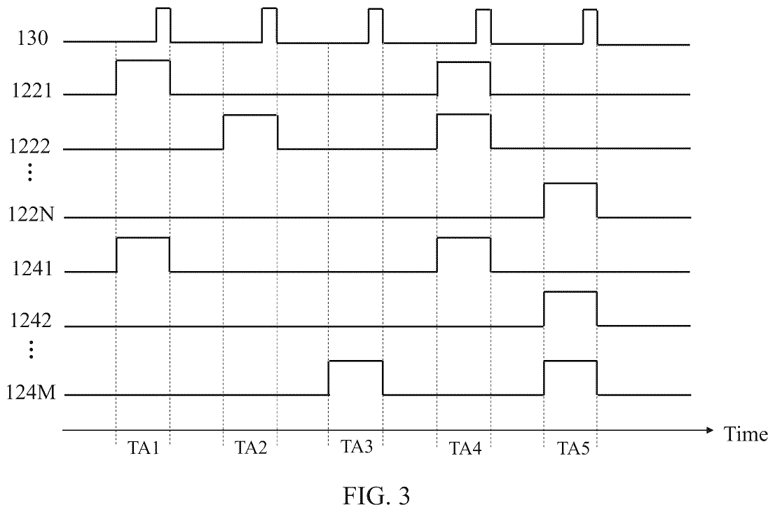

For example, the control module 140 may simultaneously enable one bright field light and one dark field light to illuminate the die to be inspected. FIG. 3 shows a timing diagram of operations of the illumination device 120 and the sensing device 130 according to an embodiment of the present disclosure. As shown in FIG. 3, in a light sensing time period TA1, the control module 140 may simultaneously enable the light sources 1221 and 1241 to illuminate the die to be inspected, and control the sensing device 130 to sense a reflected light from the die in the light sensing time period TA1 to generate a set of image data corresponding to a light source combination of the light sources 1221 and 1241.

In some embodiments, the control module 140 may enable only one single bright field light source. For example, in a light sensing time period TA2 in FIG. 3, the control module 140 may enable only the light source 1222 to illuminate the die to be inspected, and control the sensing device 130 to sense a reflected light from the die in the light sensing time period TA2 to generate a set of image data corresponding to a light source combination of the light source 1222.

In some embodiments, the control module 140 may enable only one single dark field light source. For example, in a light sensing time period TA3 in FIG. 3, the control module 140 may enable only the light source 124M to illuminate the die to be inspected, and control the sensing device 130 to sense a reflected light from the die in the light sensing time period TA3 to generate a set of image data corresponding to a light source combination of the light source 124M.

In some embodiments, the control module 140 may enable multiple bright field light sources. For example, in a light sensing time period TA4 in FIG. 3, the control module 140 may enable the light sources 1221 and 1222 to illuminate the die to be inspected. Moreover, in this embodiment, the control module 140 may further enable the dark field light source 1241 together with the light sources 1221 and 1222 to illuminate the die to be inspected, and control the sensing device 130 to sense a reflected light from the die in the light sensing time period TA4 to generate a set of image data corresponding to a light source combination of the light sources 1221, 1222 and 1241.

In some embodiments, the control module 140 may enable multiple dark field light sources. For example, in a light sensing time period TA5 in FIG. 3, the control module 140 may enable the light sources 1242 and 124M to illuminate the die to be inspected. Moreover, in this embodiment, the control module 140 may further enable the bright field light source 122N together with the light sources 1242 and 124M to illuminate the die to be inspected, and control the sensing device 130 to sense a reflected light from the die in the light sensing time period TA5 to generate a set of image data corresponding to a light source combination of the light sources 1242, 124M and 122N.

In other words, the control module 140 may use different combinations of light sources to illuminate the die to be inspected and obtain corresponding image data. After the multiple sets of image data of each of the dies is obtained, the computing module 150 may receive the multiple sets of image data of each of the dies, train a deep learning model 152 (for example, a machine learning model) according to the multiple sets of image data of the multiple dies to determine multiple classification features, and determine levels of similarity of these dies according to these classification features so as to classify these dies.

In general conditions, since a good die may not have noticeable defects, image data of each good die is expected to be very similar to or substantially same as that of other good dies in a situation where the same combination of light sources is used, and thus good dies should be classified to a same category. In contrast, positions or patterns of defects of various defective dies may differ from one another. Thus, in a situation where the same combination of light sources is used, image data of individual defective dies may be presented differently such that the individual defective dies may be classified into various categories. Moreover, the ratio of good dies in samples is usually higher than the ratio of defective dies in the samples (for example, the ratio of the good dies may be higher than 90%). Therefore, in the present embodiment, the computing module 150 may utilize the deep learning model 152 to categorize the dies determined to be the same into a same category, define the dies that belong to a first category having a greatest number of dies die as first-category dies (that is, the majority would be good dies), and define the dies that do not belong to the first category as second-category dies (that is, the minority would be defective dies).

In other words, with the analysis performed by the deep learning model 152 on the levels of similarity of a large amount of image data of a large amount of dies, the deep learning model 152 may determine classification features suitable for determining the levels of similarity in multiple rounds of training, so as to distinguish the dies into the first-category dies in majority that are the same and the second-category dies in minority that are different from the first-category dies. Next, the computing module 150 may label images of the first-category dies as standard images, and label images of the second-category dies as defect images. As such, without needing to provide reference images of good dies, the wafer inspection system 100 is able to train the computing module 150 directly by the image data of samples of dies, and utilize the deep learning model 152 for inference to distinguish the dies into different categories (for example, into good dies and defective dies). In some embodiments, when image data of more die samples of the wafer to be tested is input to the computing module 150, the computing module 150 may continue using the image data as well as the labeled standard images and defect images to train the deep learning model 152, enabling the deep learning model 152 to determine classification features and weightings thereof that are more effective, thereby improving the accuracy in distinguishing the good dies from the defective dies.

In some embodiments, the deep learning model 152 may be a neural network model, for example but not limited to, a convolutional neural network model. The convolutional neural network model may include a convolutional layer that extracts features, a pool layer configured to sample the features, a flattening layer configured to convert dimensions of the features, and a fully connected layer configured for classification. The wafer inspection system 100 may obtain multiple sets of image data of each of the dies (for example but not limited to, 100 or more images can be obtained for each of the dies) according to multiple different inspection parameters (for example, for illumination with different combinations of light sources). Thus, there is a chance for the deep learning model 152 to extract effective classification features from a large amount of different types of data to improve classification accuracy thereof.

Moreover, in some embodiments, the computing module 150 can be further configured to train a deep learning model 154 according to the multiple sets of image data of the second-category dies to categorize the second-category dies, thereby distinguishing the types of defects of the second-category dies. That is to say, the computing module 150 may utilize the deep learning model 154 to further perform categorization according to the respective levels of similarity of the second-category dies, thereby distinguishing different types of defects.

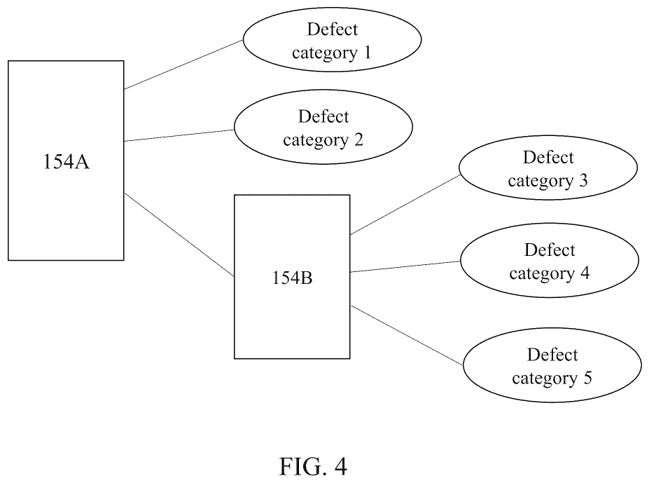

In some embodiments, the computing module 150 may utilize a multilayer deep learning model to categorize the second-category dies. FIG. 4 is a schematic diagram of a multilayer deep learning model according to an embodiment of the present disclosure. As shown in FIG. 4, a deep learning model 154A may distinguish the second-category dies into a defect category 1 and a defect category 2. Since the classification features determined by the deep learning model 154A cannot further categorize the dies that are in neither the defect category 1 nor the defect category 2, feature data of the dies that are categorized in neither the defect category 1 nor the defect category 2 may be further input to a deep learning model 154B, which then further distinguishes the dies that are not yet categorized into a defect category 3, a defect category 4 and a defect category 5.

In some embodiments, according to actual application requirements, the computing module 150 may utilize a single-layer or multilayer deep learning model for defect categorization. Similarly, the computing module 150 may also utilize a single-layer or multilayer deep learning model for categorization of good dies and defective dies. Moreover, in some embodiments, the control module 140 and the computing module 150 may be implemented by program codes executed by different or the same processors in a same computer system, or may be implemented by corresponding program codes executed by processors in different computer systems.

In some embodiments, in addition to training the deep learning model 152 according to the multiple sets of image data of each of the dies, the computing module 150 may further overlay some of the image data to generate overlaid image data, and train the deep learning model 152 according to the image data of each of the dies and the overlaid image data. For example, the computing module 150 may overlay the image data obtained in the light sensing time period TA4 and the light sensing time period TA5 in FIG. 3 to generate overlaid image data of the two (for example, by overlaying two photographs), and overlay the image data obtained in the light sensing time period TA1, the light sensing time period TA2 and the light sensing time period TA3 to obtain overlaid image data of the three. In such case, the computing module 150 may together input the image data of the dies sensed by the sensing device 130 in the light sensing time periods TA1, TA2, TA3, TA4 and TA5 and the overlaid image data generated by overlaying some of the image data to the deep learning model 152 for training. By overlaying different image data to generate overlaid images, the amount of information received by the deep learning model 152 may be further increased, thereby providing the deep learning model 152 with a greater chance of selecting classification features that are more effective.

In the embodiment in FIG. 3, the control module 140 may simultaneously enable corresponding light sources in each of the light sensing time periods to allow the sensing device 130 to obtain image data corresponding to the combination of light sources; however, the present disclosure is not limited to the example above. In some embodiments, in each of the light sensing time periods, the control module 140 may enable different light sources according to a predetermined time sequence and have the sensing device 130 be continually exposed, so as to obtain image data generated by reflected lights from the dies to be inspected illuminated by the light sources according to the predetermined time sequence.

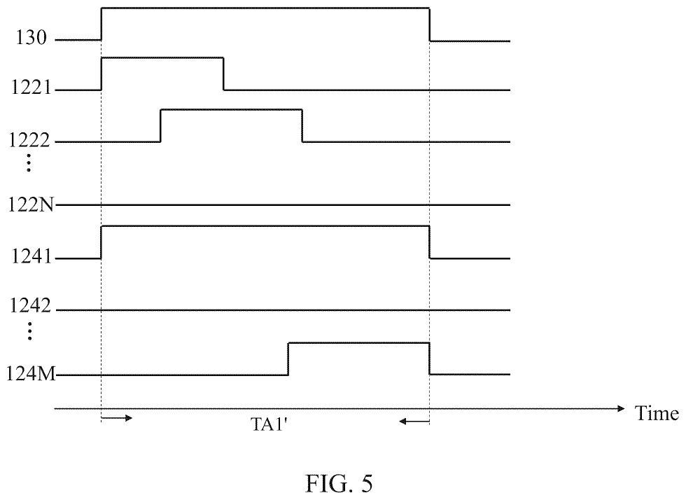

FIG. 5 shows a timing diagram of operations of the illumination device 120 and the sensing device 130 according to an embodiment of the present disclosure. In FIG. 5, the control module 140 may select the light sources 1221, 1222, 1241 and 124M in the illumination device 120 as predetermined light sources. In a light sensing time period TA1′, the control module 140 may sequentially enable the predetermined light sources 1221, 1222 and 124M, and at the same time keep the predetermined light source 1241 enabled the whole time. Moreover, the control module 140 may control the sensing device 130 to be continually exposed in the light sensing time period TA1′. Thus, corresponding image data may be generated by reflected lights from the dies to be inspected illuminated by the predetermined light sources 1221, 1222, 1241 and 124M according to the predetermined time sequence. In other words, in addition to obtaining the image data of each of the dies according to a combination of predetermined light sources, the control module 140 may further enable light sources of a predetermined combination of light sources according to a predetermined time sequence, so as to obtain image data containing richer information. In some embodiments, by obtaining multiple sets of image data of dies, the amount of information received by the deep learning model 152 may be further increased, thereby helping the deep learning model 152 to select effective classification features.

Moreover, in the embodiments in FIG. 3 and FIG. 5, in each of the light sensing time periods in which the sensing device 130 obtains the image data, the inspection platform 110 may keep the die to be inspected (or wafer to be inspected) still; however, the present disclosure is not limited to the example above. In some embodiments, the inspection platform 110 may move the die to be inspected in a predetermined light sensing time period, and control the sensing device 130 to be continually exposed in the light sensing time period so as to generate image data according to the reflected light from the die in motion.

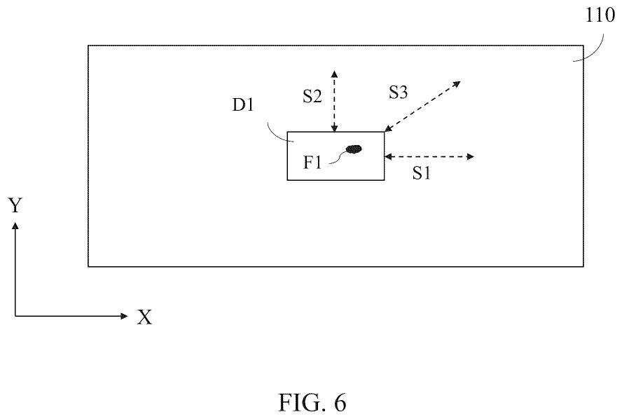

FIG. 6 shows a schematic diagram of the inspection platform 110 moving a die D1 according to an embodiment of the present disclosure. In FIG. 6, the inspection platform 110 may, for example, move the die D1 along a straight line S1 in an X direction. When the die D1 to be inspected moves toward the right along the straight line S1 (e.g., in the direction where the X-axis component increases), pronounced light and shadow variation may appear on a right boundary of a defect F1 of the die D1. In contrast, when the die D1 to be inspected moves toward the left direction along the straight line S1 (e.g., in the direction where the X-axis component decreases), pronounced light and shadow variation may appear on a left boundary of a defect F1 of the die D1. In some embodiments, the inspection platform 110 may move the die D1 back and forth on the straight line S1, so that the left boundary and the right boundary of the defect F1 can be emphasized during the moving process. Moreover, in some embodiments, the inspection platform 110 may also move the die D1 along a straight line S2 in a Y direction, so as to emphasize a boundary on an upper side (e.g., the side toward which the Y-axis component increases) and/or a lower side (e.g., the side toward which the Y-axis component decreases) of the defect F1 of the die D1. Alternatively, in some embodiments, the inspection platform 110 may move the die D1 along a straight line S3 between the X direction and the Y direction, so as to emphasize a boundary on an upper-right side and/or a lower-left side of the defect F1 of the die D1.

Because the image data obtained during a moving process of the die D1 can emphasize certain defects, using such type of image data as input data to the deep learning model 152 also helps the deep learning model 152 to obtain more effective classification features, thereby improving the classification accuracy of the deep learning model 152.

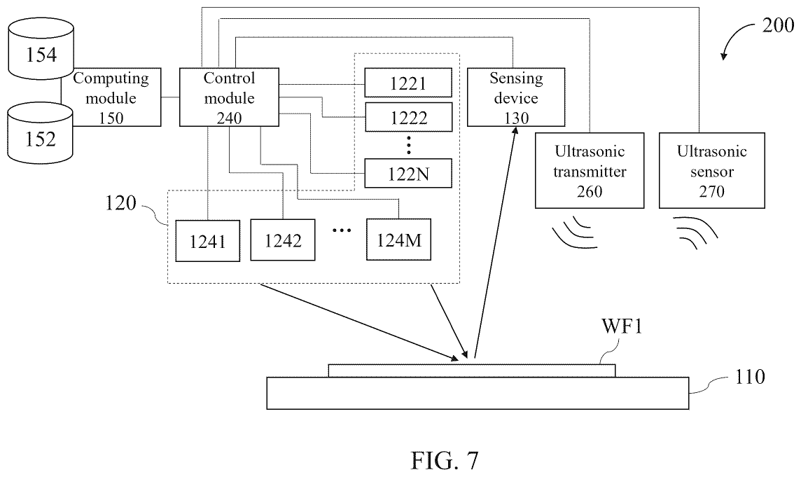

In addition, in some embodiments, the wafer inspection system may also use ultrasonic waves to inspect wafer, and use ultrasonic image data of dies to train a deep learning model thereof. FIG. 7 shows a schematic diagram of a wafer inspection system 200 according to an embodiment of the present disclosure. The wafer inspection system 200 differs from the wafer inspection system 100 in that, the wafer inspection system 200 may further include an ultrasonic transmitter 260 and an ultrasonic sensor 270, and a control module 240 may be further coupled to the ultrasonic transmitter 260 and the ultrasonic sensor 270. In the present embodiment, for each of the dies, the control module 240 may control the ultrasonic transmitter 260 to transmit at least one ultrasonic wave to the die in at least one ultrasonic sensing time period, and control the ultrasonic sensor 270 to obtain at least one set of ultrasonic image data of the die in the at least one ultrasonic sensing time period.

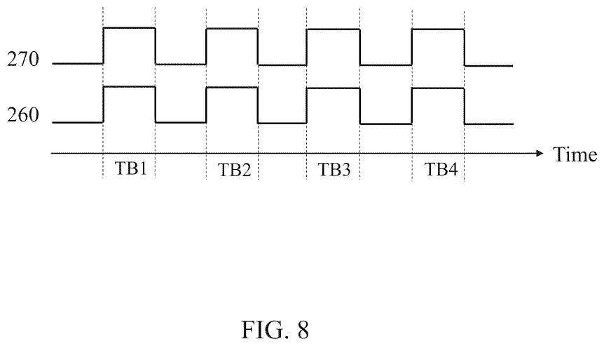

In some embodiments, a frequency of the ultrasonic wave transmitted by the ultrasonic transmitter 260 may range between 0.5 MHz and 25 MHz, and the control module 240 may control the ultrasonic transmitter 260 to transmit ultrasonic waves in different wavebands to the die to be inspected in multiple ultrasonic sensing time periods to obtain corresponding ultrasonic image data. FIG. 8 shows a timing diagram of operations of the ultrasonic transmitter 260 and the ultrasonic sensor 270 according to an embodiment of the present disclosure. As shown in FIG. 8, the control module 240 may control the ultrasonic transmitter 260 to transmit ultrasonic waves in, for example, 1 MHz, 5 MHz, 10 MHz and 15 MHz to the die to be inspected in time periods TB1, TB2, TB3 and TB4, respectively, and the ultrasonic sensor 270 may obtain different sets of image data corresponding to the ultrasonic waves of the die to be inspected in the time periods TB1, TB2, TB3 and TB4, respectively. In such case, in addition to training the deep learning model 152 according to the multiple sets of image data of the die obtained under different light source combinations provided by the illumination device 120, the computing module 150 may further use the multiple sets of ultrasonic image data of the die to train the deep learning model 152. Because ultrasonic waves are able to present images of internal structures of dies, the amount of information received by the deep learning model 152 may be further increased, thereby helping the deep learning model 152 to select effective classification features.

Sensing for reflected lights from dies and sensing for ultrasonic waves reflected from dies may be separately performed by the sensing device 130 and the ultrasonic sensor 270. Thus, in some embodiments, the light sensing time periods (for example, the light sensing time periods TA1, TA2, TA3, TA4 and TA5 in FIG. 3) for sensing reflected lights and the ultrasonic sensing time periods (for example, the ultrasonic sensing time periods TB1, TB2, TB3 and TB4 in FIG. 3) for sensing reflected ultrasonic waves may be at least partially overlapping or non-overlapping.

In addition, in some embodiments, the computing module 150 may overlay image data corresponding to different light source combinations to generate overlaid image data, and may further overlay image data from light sensing and image data from ultrasonic sensing to generate the overlaid image data. As such, the computing module 150 may use the image data from light sensing, the ultrasonic image data, and the overlaid image data to train the deep learning model 152, thereby increasing the amount of information received by the deep learning model 152 and helping to improve the classification accuracy of the deep learning model 152.

In some embodiments, input data for the deep learning model 152 may be applied to the deep learning model 154 to further categorize defects of defective dies. In other words, the computing module 150 may similarly use the image data from light sensing, the ultrasonic image data, and the overlaid image data to train the deep learning model 154, thereby increasing the amount of information received by the deep learning model 154 and helping to improve the classification accuracy of the deep learning model 154.

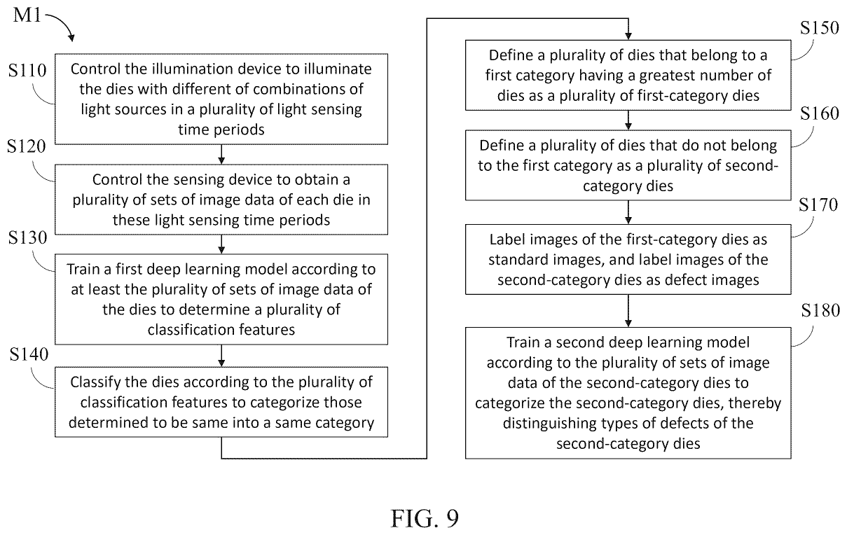

FIG. 9 shows a flowchart of a method M1 performed by a wafer inspection system according to an embodiment of the present disclosure. The method M1 includes steps S110 to S180. In some embodiments, the method M1 may be performed by the control module 140 and the computing module 150 of the wafer inspection system 100. For example, in step S110, the control module 140 may control the illumination device 120 to illuminate a die with multiple different combinations of light sources in multiple light sensing time periods. In step S210, the control module 140 may control the sensing device 130 to obtain multiple sets of image data of the die in the light sensing time periods. The computing module 150 may train the deep learning model 152 according to the multiple sets of image data of each of the multiple dies to determine multiple classification features in step S130, and determine levels of similarity of the dies according to the classification features to classify the dies so as to categorize the dies determined to be the same into a same category in step S140. Next, in step 150 and step 160, the multiple dies that belong to a first category having a greatest number of dies may be defined as multiple first-category dies, and the multiple dies that do not belong to the first category are defined as multiple second-category dies. In step S170 and step S180, the computing module 150 may further label images of the first-category dies as standard images, label images of the second-category dies as defect images, and train the second deep learning model 154 according to multiple sets of image data of the second-category dies to categorize the second-category dies, thereby distinguishing types of defects of the second-category dies.

In conclusion, the wafer inspection system and the method of operating the wafer inspection system provided by the embodiments of the present disclosure may use different combinations of light sources to obtain multiple sets of image data of each die, and use a large amount of image data to train a deep learning model for analysis on levels of similarity, hence distinguishing good dies and defective dies without involving standard reference images. Moreover, the wafer inspection system of the present invention may obtain diversified image data during a sensing stage by controlling light sources with different sequence, moving dies, using ultrasonic sensing images and overlaying different image data, thereby further increasing the amount of information used for training a deep learning model, enabling the deep learning model to extract more effective classification features and weightings thereof and hence improving determination accuracy.

What is claimed is:

1. A wafer inspection system, comprising:
an inspection platform, configured to accommodate a piece of wafer to be inspected comprising a plurality of dies;
an illumination device, comprising a plurality of light sources, configured to illuminate the wafer to be inspected;
a sensing device, configured to sense lights reflected from the wafer to be inspected;
a control module, coupled to the illumination device and the sensing device, configured to, for each of the plurality of dies, control the illumination device to illuminate the die with a plurality of combinations of light sources in a plurality of light sensing time periods, and control the sensing device to obtain a plurality of sets of image data of the die in the light sensing time periods, wherein each of the plurality of combinations of light sources comprises at least one of the plurality of light sources; and
a computing module, configured to receive a plurality of sets of image data of the plurality of dies, train at least one first deep learning model to determine a plurality of classification features according to the plurality of sets of image data of the plurality of dies, classify the plurality of dies according to the plurality of classification features to categorize those determined to be same into a same category, define a plurality of dies that belong to a first category having a greatest number of dies as a plurality of first-category dies, and define a plurality of dies that do not belong to the first category as a plurality of second-category dies.

2. The wafer inspection system according to claim 1, wherein the computing module is further configured to label images of the plurality of first-category dies as standard images, and label images of the plurality of second-category dies as defect images.

3. The wafer inspection system according to claim 2, wherein the computing module is further configured to train at least one second deep learning model according to a plurality of sets of image data of the plurality of second-category dies to categorize the plurality of second-category dies, thereby distinguishing types of defects of the plurality of second-category dies.

4. The wafer inspection system according to claim 1, wherein the light sources comprise:
a plurality of bright field light sources, wherein any two of the bright field light sources correspond to different wavebands, different intensities, different polarization states, or any combination thereof.

5. The wafer inspection system according to claim 1, wherein the light sources comprise:
a plurality of dark field light sources, wherein any two of the dark field light sources correspond to different illumination angles, different wavebands, different intensities, different polarization states, or any combination thereof.

6. The wafer inspection system according to claim 1, wherein the light sources comprise:
a plurality of backlight light sources, wherein any two of the backlight light sources correspond to different wavebands, different intensities, different polarization states, or any combination thereof.

7. The wafer inspection system according to claim 1, further comprising:
an ultrasonic transmitter, configured to transmit ultrasonic waves to the plurality of dies; and
an ultrasonic sensor;
wherein the control module is further coupled to the ultrasonic transmitter and the ultrasonic sensor, and the control module is further configured to, for each of the plurality of dies, control the ultrasonic transmitter to transmit at least one ultrasonic wave to the die in at least one ultrasonic sensing time period, and control the ultrasonic sensor to obtain at least one set of ultrasonic image data of the die in the at least one ultrasonic sensing time period.

8. The wafer inspection system according to claim 7, wherein the at least one ultrasonic sensing time period comprises a plurality of ultrasonic sensing time periods, and the control module controls the ultrasonic transmitter to transmit ultrasonic waves in different wavebands in the plurality of ultrasonic sensing time periods.

9. The wafer inspection system according to claim 7, wherein the at least one ultrasonic sensing time period of the die and the plurality of light sensing time periods are at least partially overlapping.

10. The wafer inspection system according to claim 7, wherein the computing module is further configured to receive a plurality of sets of ultrasonic image data of the plurality of dies, and the computing module trains the at least one first deep learning model according to the plurality of sets of image data and the plurality of sets of ultrasonic image data of the plurality of dies.

11. The wafer inspection system according to claim 10, wherein the computing module is further configured to generate at least one set of overlaid image data of the die according to at least two sets of the plurality of sets of image data and the at least one set of ultrasonic image data of the die, and the computing module trains the at least one first deep learning model according to the plurality of sets of image data, the plurality of sets of ultrasonic image data, and a plurality of sets of overlaid image data of the plurality of dies.

12. The wafer inspection system according to claim 1, wherein the computing module is further configured to generate at least one set of overlaid image data of the die according to at least two sets of the plurality of sets of image data of the die, and the computing module trains the at least one first deep learning model according to the plurality of sets of image data and a plurality of sets of overlaid image data of the dies.

13. The wafer inspection system according to claim 1, wherein in a first light sensing time period of the plurality of light sensing time periods of the die, the control module controls a plurality of predetermined light sources of the plurality of light sources to illuminate the die according to a predetermined time sequence, and controls the sensing device to be continually exposed in the first light sensing time period to generate a set of image data according to a reflected light from the die sequentially illuminated by the predetermined light sources.

14. The wafer inspection system according to claim 1, wherein in a first light sensing time period of the plurality of light sensing time periods of the die, the control module controls the inspection platform to move the die, and controls the sensing device to be continually exposed in the first light sensing time period to generate a set of image data according to a reflected light from the die in motion.

15. The wafer inspection system according to claim 14, wherein the inspection platform moves the die along a straight line in the first light sensing time period.

16. A method for wafer inspection using a wafer inspection system, the wafer inspection system comprising an inspection platform, an illumination device, a sensing device, a control module, and a computing module, the control module coupled to the illumination device and the sensing device; the method comprising:
accommodating, by the inspection platform, a piece of wafer to be inspected, wherein the wafer to be inspected comprises a plurality of dies;
controlling, by the control module, the illumination device to illuminate each of the dies with a plurality of combinations of light sources in a plurality of light sensing time periods;
controlling, by the control module, the sensing device to obtain a plurality of sets of image data of each of the plurality of dies in the plurality of light sensing time periods, wherein each of the plurality of combinations of light sources comprises at least one of the plurality of light sources;
training, by the computing module, at least one first deep learning model according to at least the plurality of sets of image data of the dies to determine a plurality of classification features;
classifying, by the computing module, the plurality of dies according to the plurality of classification features to categorize those determined to be same into a same category;
defining, by the computing module, a plurality of dies that belong to a first category having a greatest number of dies as a plurality of first-category dies; and
defining, by the computing module, a plurality of dies that do not belong to the first category as a plurality of second-category dies.

17. The method according to claim 16, further comprising:
labeling, by the computing module, images of the plurality of first-category dies as standard images, and labeling images of the plurality of second-category dies as defect images.

18. The method according to claim 17, further comprising:
training, by the computing module, at least one second deep learning model according to the plurality of sets of image data of the plurality of second-category dies to categorize the plurality of second-category dies, thereby distinguishing types of defects of the plurality of second-category dies.

19. The method according to claim 16, further comprising:
generating, by the computing module, at least one set of overlaid image data of the die according to at least two sets of the plurality of sets of image data of the die; and
training, by the computing module, the at least one first deep learning model according to the plurality of sets of image data and a plurality of sets of overlaid image data of the dies.

20. The method according to claim 16, further comprising:
controlling, by the control module, the inspection platform to move the die in a first light sensing time period of the plurality of light sensing time periods of the die; and
controlling, by the control module, the sensing device to be continually exposed in the first light sensing time period to generate a set of image data according to a reflected light from the die in motion.
